(19) United States
(12) Patent Application Publication
(10) Pub. No.: US 2005/0125333 A1
(43) Pub. Date: Jun. 9, 2005

(54) Pre-order wholesale system and method

(76) Inventor: Isaia Paolo Giannetti, Arlington, MA (US)

Correspondence Address: Isaia Giannetti, 76 Amsden St., Arlington, MA, 02474, US

(21) Appl. No.: 10/993,779

(22) Filed: Nov. 20, 2004

Related U.S. Application Data
(60) Provisional application No. 60/528,152, filed on Dec. 9, 2003.

(51) Int. Cl. G06F 17/60

(52) U.S. Cl. 705/37

(57) ABSTRACT

The present invention provides a method and system that generates buying trends toward more popular products in an auction forum. It enables buyers to pool their buying power by allowing them to place a non-binding bid on an item, monitor their bid and the bids of all other consumers on the network, and instantly change their bid to a more popular item in order to create instant trends toward more popular items, creating higher order quantities that correspond to lower prices.

The present patent application claims priority to the corresponding provisional patent application Ser. No. 60/528,152, titled, “PRE-ORDER WHOLESALE SYSTEM”, filed Dec. 9, 2003.

### BACKGROUND

The existing group shopping systems on the internet provide a selection of items. Each item lists a price and the number of people who have agreed to buy it at that price. Each item also has a paragraph explaining that if X number of people agree to buy the item at the current price, the price will fall by $Y The lower price is applied retroactively to everyone who agreed to pay the higher price. Certain systems specify how much the price will fall as more buyers sign on, by establishing demand thresholds, while others do not utilize demand thresholds.

The characteristic that these systems have in common is that the bids are binding. “Irrevocable purchase offers”, as stated in U.S. Pat. No. 6,631,356 to Van Horn, are made by potential buyers. This means that once a bid has been made, and the lowest aggregate threshold has been reached, the buyer must purchase the product whether or not the highest aggregate threshold is eventually reached. In the present invention a bid only becomes binding if the highest aggregate threshold is reached or if the time limit is reached and at least one of the lower thresholds is met, which enables consumers to retract their bids at the last minute if not satisfied with lower the threshold price.

Quantity pricing is conventional. Aggregate demand thresholds are conventional. Demand-based pricing is conventional. The present invention provides a new paradigm for conducting an auction by allowing buyers to place their bids without financial commitment, and later instantaneously change their bids in real time from one product to another, to create instant trends toward more popular products. This creates a retail environment in which all consumers in the network are be able to react instantaneously to developing trends and generate numerically larger orders than would otherwise be feasible had they not the faculty of changing their bids. Attempts at creating such trends have been made by various group buying systems such as U.S. Pat. No. 6,269,343 to Pallakoff which lets potential buyers alert their friends when demand thresholds are almost reached. An example message in Pallakoff's system is: “We just need 5 more people to join the Buying Team in order to get the Soccer Balls for only $10 each. Tell your friends!”.Another example is U.S. Pat. No. 6,631,356 to Van Horn which offers a “Volume Building Communication Feature” that allows buyers an opportunity to e-mail friends and acquaintances to tell them about the extraordinary deal being offered in their co-op. A third example is U.S. Pat. No. 6,584,451 to Shoham which discloses, after an initial bidding phase, potential prices and the additional quantity of buyers needed to achieve each price point with the intent of attracting buyers who are “scared by the low quantity price” and incentivizing buyers to “evangelize or raise their own bids to get in on the deal.” The present invention, with the introduction of non-binding and changeable bids, eliminates the need for such features.

### SUMMARY OF THE INVENTION

The present invention provides a method and system which creates a live interactive environment that generates buying trends toward more popular products in a real-time setting. It enables buyers to pool their buying power by allowing them to place a non-binding bid on an item, monitor their bid and the bids of all other consumers on the network, and instantly change their bid to a more popular item in order to create instant trends toward more popular items, creating higher order quantities that correspond to lower prices.

The POW system offers the stock market-like experience of following fluctuating prices and bidding on products in a live setting without any financial risk. The existing group sales systems can not provide this experience, because they lack the non-binding and changeable bid feature. The primary innovation consists, therefore, not in the way manufacturers collect individual orders and assign a price to the aggregate order, but rather in the way consumers are able to decide what products to ultimately purchase based on generated trends among the network of consumers. The present invention may also be used as a tool to predict consumer demand on one or more products if utilized for products not yet in production.

### BRIEF DESCRIPTION OF THE DRAWINGS

FIG. 1 is an overall diagram of the system.

FIG. 2 illustrates the elements on a web page for a suggested embodiment.

FIG. 3 is a high level flow diagram of the various operations that take place.

FIG. 4 is a program flow diagram of a seller specifying an offer.

FIG. 5 is a program flow diagram of presenting offers on a web site.

FIG. 6 a program flow diagram of a potential buyer adding a Pre-order.

FIG. 7 a program flow diagram of a potential buyer removing a Pre-order.

FIG. 8 is a program flow diagram of a offer being accepted.

FIG. 9 is a program flow diagram of an offer being cancelled.

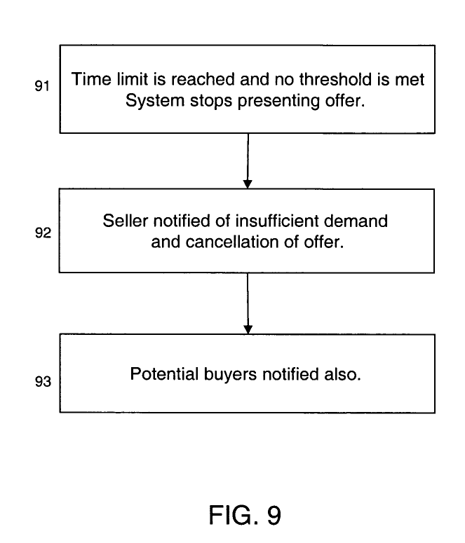

### DESCRIPTION OF PREFERRED EMBODIMENTS

Certain terms as used herein are defined as follows:
Pre-Order: A changeable bid that does not become binding until highest threshold is reached or the time /date limit is reached and a minor threshold is met.
Demand Aggregation: Consolidating demand by potential buyers for products offered by sellers.
Demand-Based Pricing: A method of pricing which requires that prices go down as the volume of units sold goes up.
Product: Either a product or service.
Group Buying: A method in which multiple buyers come together in a group to buy products in volume.
Aggregate Demand: The total amount of products that buyers have indicated a desire to buy.
Demand Threshold or Aggregate Demand Threshold: The Aggregate Demand required for a product to be sold at a particular price.
Highest Demand Threshold or Maximum Demand Threshold: The Demand Threshold above which the price will not decrease further, irrespective of further increases in Aggregate Demand.
Buying Cycle: The period during which buyers can indicate a desire to purchase a product. At the end of a buying cycle, the demand is aggregated (counted) to determine the price at which the product is actually sold.
Maximum Available Amount: The maximum amount of a product that a seller is willing to sell during a Buying Cycle.
System Operator: An individual, company, party, or other entity that operates or is responsible for the computer system or web server that performs various calculations and operations hereinafter described.

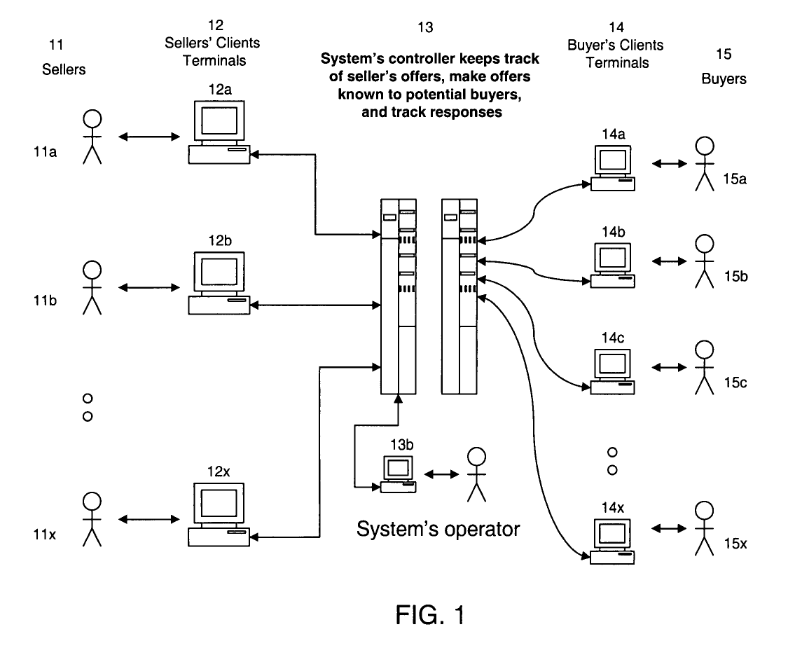

An overall diagram of a first preferred embodiment of the invention is shown in FIG. 1. In general, the system connects sellers 11 with buyers 15 by means of a system controller 13. The sellers are designated 11a to 11x and are collectively referred to as sellers 11. The buyers are designated 15a to 15x and are collectively referred to as buyers 15. There can be many buyers and many sellers; however, the actual numbers of buyers and sellers is not relevant as long as there is at least one seller and one buyer. The sellers 11 communicate with the controller 13 via terminals 12 (individually designated 12a to 12x) and the buyers 15 communicate with the controller 13 via terminals 14 (individually designated 14a to 14x). Typically but not necessarily communication is via the Internet. As is conventional, terminals 12 and 14 are connected to an ISP (Internet Service Provider) which provides access to the Internet. Likewise controller 13 is connected to the Internet via an ISP. The lines in FIG. 1 therefore represent logical information flow and not physical connections. The sellers 11 and the buyers 14 can be described as being online. Sellers' client terminals 14 can be any of the various types of terminals that are available such as computers, laptops, thin-clients, WebTVs, Interactive TVs, PDAs, Information Appliances, or any other device that can be used by sellers to access the system's controller 13 over a network, so sellers can specify offers of goods and services. The system controller 13 is one or more conventional network servers running software to keep track of sellers' offers (including optional conditions); “intelligently” control appearance of the offers on one or more physical or “virtual” media (e.g. web sites); and appropriately track and/or process purchase requests, by buyers who may see and respond to those offers.

The System Operator 13b utilizes a conventional client terminal to access and configure the system's controller 13 as is conventional with computer systems and network servers. The buyers' client terminals 14 are any of the various conventional terminals that are used to access web sites such as computers, laptops, thin-clients, WebTVs, two-way TV, PDAs, information appliances, or any other devices that buyers can use to view or hear offers presented by controller 13. Buyers also respond to offers using client terminals 14.

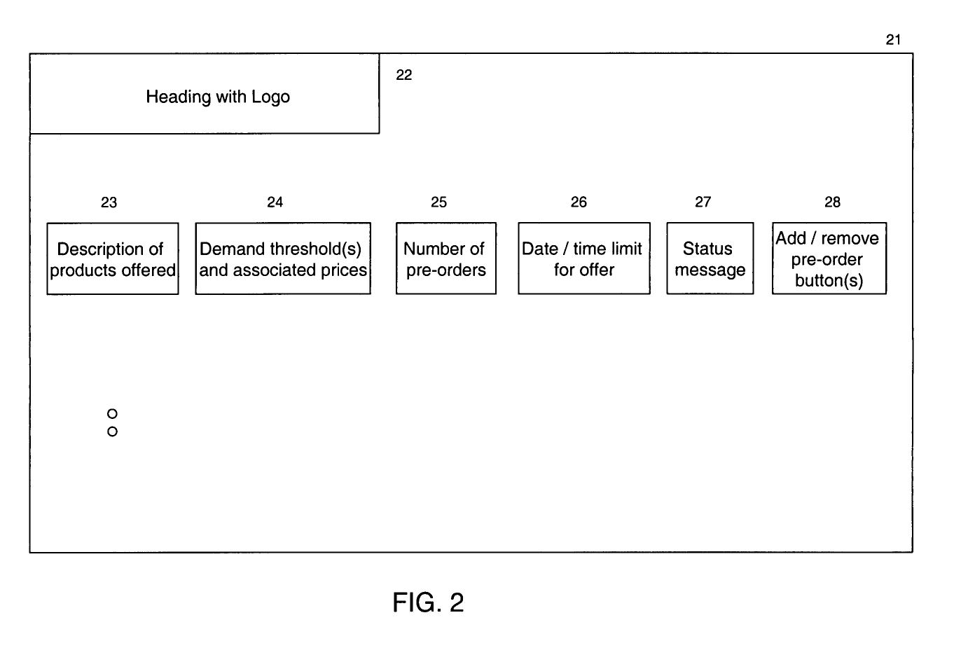

FIG. 2 is a diagram illustrating the elements on a web page 21 which the controller 13 presents to buyers 15. It is noted that FIG. 2 merely illustrates the fields that are relevant to a preferred embodiment of the invention. FIG. 2 is not meant to illustrate the actual layout of a web page. An actual web page would be laid out in such a manner as the sponsor of the web site or the web site owner deems fit. The esthetic nature and the visual appearance of the web page are not relevant to the present invention. The fields or elements on web page are:
a) A conventional heading and logo 22 may be included to identify who is sponsoring the web page, however, such a field is not actually necessary to the operation of the system.
b) A field 23 which describes the product being offered for sale.
c) A field 24 which lists the price of the product at various demand levels. For example, this field might indicate:
at 50—$100.00
at 100—$85.00
at 150—$70.00

In this example, the Demand Thresholds are 50, 100, and 150. The lowest Demand Threshold is 50, meaning that the offer will be cancelled unless at least 50 units are sold. The Maximum Demand Threshold is 150, meaning that the price will not drop any lower than $70.00 in this offer. The price will drop to $70.00 only when buyers order, in aggregate, at least 150 units during the buying cycle.

This field can also specify a Maximum Available Amount. For Example, if the seller wanted to sell a maximum of 200 units (perhaps because only 200 items were in the seller's inventory), then the quantities and price could be specified as:
at 50—$100.00
at 100—$85.00
at 150 to 200—$70.00

In this example, the Maximum Available Amount is 200.
d) A field 25 which indicates the number of Pre-Orders that is the Aggregate Demand for a product at any given moment before confirmation of sale. Optionally this field may also indicate how many individual buyers have thus far indicated a desire to buy the product. And this field may also optionally indicate the Maximum Available Amount level for this offer.
e) A field 26 which indicates the date and time when the buying process or cycle will terminate.
f) A field 27 for various status messages.
g) A button(s) 28 on which a user can “click” to indicate a desire to place or remove Pre-order(s).

Web page 21 as described above relates to selling a single product. It should be noted that a single web page could offer multiple products. The fields described above could be repeated, one set of fields for each product, or each field could have information on multiple products. Furthermore, in addition to having the fields described the above web page could include numerous other unrelated fields with other unrelated information or advertisements.

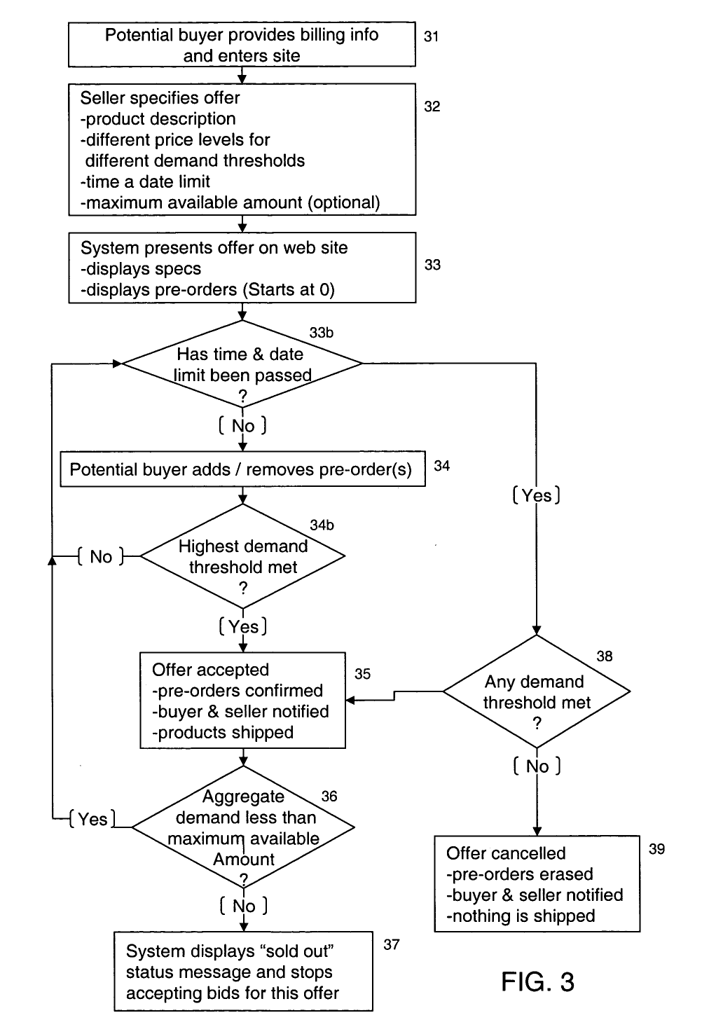

FIG. 3 is an overall flow diagram of the operation of the system. The process begins with the potential buyer submitting his/her billing information, entering site, and viewing offer(s) on the site (block 31). For example, users might submit credit card information and address. Optionally, billing information may also be collected when user “clicks” Pre-Order button to indicate desire to add a pre-order to the aggregate number. The process continues with a seller making an offer to sell a particular product at specified prices which depend upon the amount of the product that can be sold in a particular time period (block 32). For example, a seller might indicate that he would sell a particular type of domestic appliance at the following prices:
at 50—$100.00
at 100—$85.00
at 150 to 200—$70.00

In this example, the Demand Thresholds are 50, 100, and 150, the Maximum Demand Threshold is 150, and the Maximum Available Amount is 200. The seller specifies all of the above values. It is noted that the seller may choose not to specify a Maximum Available Amount. If no Maximum Available Amount is specified then the last line in the above example would read: “at 150—$70.00”.

The seller might also specify that the buying cycle will last for X amount of time. For example 48 hours. That is, the number of purchase requests at the end of 48 hours will determine the price at which the item will be sold, provided that one of the thresholds is met, and no purchase requests will be accepted after 48 hours.

Next, the system displays the offer(s) on the web site (block 33). The display will have the elements of information shown in FIG. 2. A buyer who sees the offer on the web site can then, if the time/date limit has not yet passed (block 33b), indicate a desire to add his/her Pre-order(s) (block 34) to this offer by clicking the “add pre-order” button 28. At this point the buyer will provide billing and shipping information (unless it was previously provided during a registration process) and the buyer must indicate the amount of product desired. This is the individual buyer's “demand” level for this offer. It will be noted that the buyer can, at any time before the time/date expiration or before the highest threshold is met, subtract his/her preorder(s) by clicking “remove pre-order” button.

At this point the system checks to determine if the Highest Demand Threshold has been met (block 34b). This is calculated by summing all of the buyers' individual demand levels for this offer. Once the Highest Demand Threshold is met, the system confirms pre-orders, notifies the buyer, and notifies the seller who may then ship the product to the buyer immediately or wait until the end of the buying cycle. (block 35). The system will continue accepting automatically confirmed pre-orders until the Maximum Available Amount has been reached. (If the seller did not specify a Maximum Available Amount, the system considers the Maximum Available Amount to be unlimited, and considers the answer to the question in block 36 to be “Yes”. That is, the Aggregate Demand is assumed always to be less than the Maximum Available Amount if no Maximum Available Amount was specified.)

If the Aggregate Demand is less than the Maximum Available Amount (block 36) then the system goes back and checks if the time and date limits still have not passed (block 33b). If the time or date limit still has not passed, the system continues to present the offer on the web site (block 33).

If (at block 36) the Aggregate Demand is not less than the Maximum Available Amount—i.e. if all of the items have been sold—then the system will display a “sold out” status message (block 37), and the system will stop accepting bids for this offer.

Note that, while FIG. 3 shows the system checking the time and date limits (block 33b) after a potential buyer adds his/her Pre-order(s), the system will additionally regularly check the time and date limit (block 33b), ideally checking every minute. (On computer operating systems and environments like Unix, windows NT, and Java, regular tasks like these can be performed using and independent software process or thread that runs in parallel with the rest of the system's processes or threads.)

Any time the system checks the offer's date or time limits (block 33b), if the offer's date or time limit has passed (for example, if the seller specified that the offer must end by 2 pm Dec. 25, 1999, and that time and date have passed), then the system proceeds to check if any of the Demand Thresholds previously specified by the seller (block 32) have been met or exceeded by the Aggregate Demand (block 38). To do this, the system checks if the Aggregate Demand (which is the total amount of product that all of the buyers have collectively, expressed a desire to buy) meets or exceeds the lowest Demand Threshold for the offer. In the domestic appliance offer example above, the lowest Demand Threshold was 50. (The seller offered to sell 50 to 99 units for $100.) So in that example, the system would check if there are a total of at least 50 pre-orders for that offer.

If the Aggregate Demand does meet or exceed the lowest Demand Threshold (block 38) then the offer can be accepted (block 35) and the buyers and sellers are notified. Otherwise the offer is cancelled (block 39) due to insufficient demand, and the buyers and sellers are so notified.

In a situation where offers are accepted (block 35) the buyers' credit cards are charged, the product is shipped to the buyers, and commissions are calculated and paid (if any). If for example the system is being operated by one entity and the products are actually being sold by a different entity, the system operator may receive a pre-negotiated commission and the actual seller will receive the remainder of the selling price.

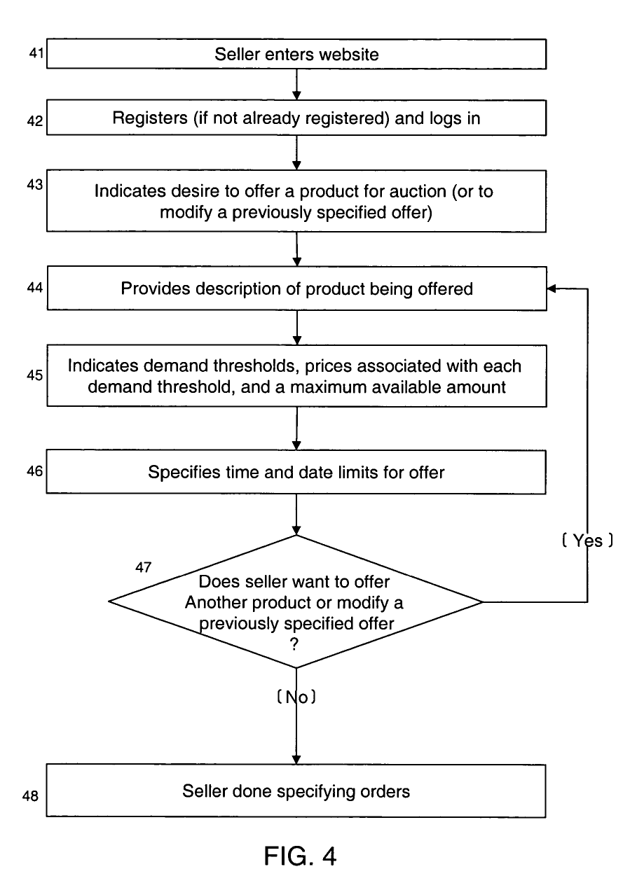

Detailed program flow diagrams of the operations shown in FIG. 3 are given in FIGS. 4 to 8. FIG. 4 is a program flow diagram for the operation of the system as the seller specifies an offer to sell a product. After the seller enters the web site (block 41) the seller registers (block 42) if he has not previously registered. In order to register, the seller provides contact information and credit information (including social security or business ID), so that the system operator can verify the seller's authenticity and credit worthiness and (if the seller looks reliable) authorize the seller to have access to the system. The system operator will provide the seller with an ID and password so the seller can log into the system. In alternative embodiments, the system's controller 13 (i.e. the system's computer servers, database, and server software) can be set to automatically check the seller's credit history, and automatically generate the Seller's ID and password or let the seller create his or her own ID and password.

After the seller is registered, the seller logs into the system (block 42), using his or her ID and password, and indicates whether he or she would like to enter the specification for an auction offer (i.e. to offer one or more units of a product or service to one or more buyers), or modify the specification for a previously entered offer (block 43).

If the seller chooses to enter a new auction offer or modify a previously entered one, the seller proceeds to enter a set of information that defines the offer. The seller starts by entering (or modifying) a description of the offer (block 44). For example, the seller might provide text (or a recorded voice) saying, “200 Brand A widgets for sale”. Next the seller specifies a Maximum Demand Threshold and a corresponding price (block 45). For example, the seller might indicate that a particular widget will be sold for $310 each if 200 can be sold during the offer. The seller can also specify additional lower Demand Thresholds and prices. For example, the seller could indicate that a particular widgets will be sold for $325 each if the Aggregate Demand is 100 or more units but less than 200 units. That is, if potential buyers wind up expressing a desire to buy (in aggregate) between 100 and 199 units, the seller will sell those units for $325 each, and if the potential buyers wind up expressing a desire to buy (in aggregate) 200 or more units, the seller will lower the per-unit price to $310 each. Finally a seller has the option of also indicating a Maximum Available Amount of product available for sale during the offer. For example, if the seller only has 300 units in inventory, the seller could set the Maximum Available Amount level to 300.

The seller also specifies a date and time limit for this offer (block 46). For example, the seller might indicate that if the lowest Demand Aggregation Threshold (100 units in the above example) is not met by noon on a certain date, the offer will be cancelled. The seller also has the option of not setting a date and time limit. However, providing a date and time limit gives buyers an incentive to act sooner, and makes it easy—automatic, in fact—for the seller to cancel the offer if there is not enough demand to satisfy the seller.

The seller can then choose to specify additional Group Buy Offers, or modify a previously specified offer (block 47). After the seller enters an offer to sell, the system 13 presents the offer on one or more web sites (block 33) until the date or time limit passes (block 33b) or the Aggregate Demand rises to the Maximum Available Amount (block 36) specified by the seller (blocks 45 and 46), if one was specified. In the preferred embodiment, the system 13 presents one or more sellers' offers on one or more web sites with web pages similar to web page 21. The web pages are accessed by buyers 15 through terminals 14a to 14x.

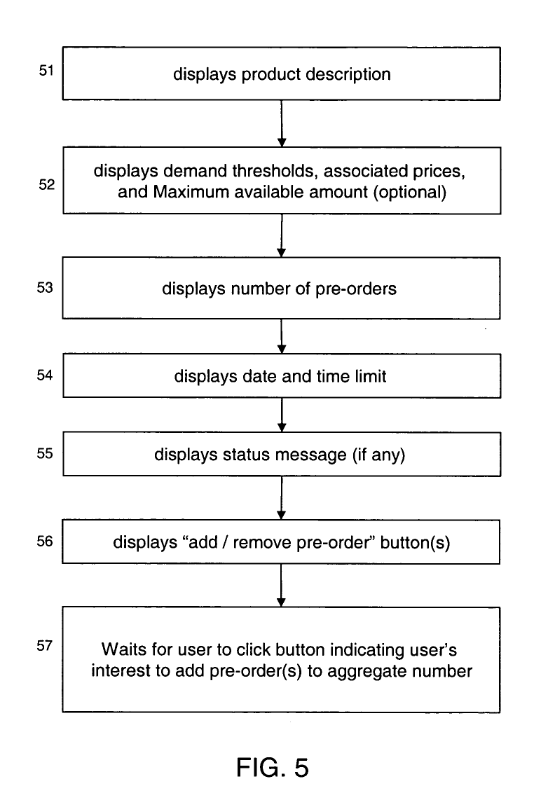

Presenting an offer on a web site involves displaying several pieces of information associated with the offer. In the preferred embodiment, the system 13 presents offers on one or more web sites as in accordance with the program flow diagram shown in FIG. 5. For each offer presented, the system will display the following information as entered by the seller or as calculated by the system controller 13: the offered product's description (block 51); the Demand Thresholds and associated Prices (block 52) and the Maximum Available Amount (if one was specified by the seller); the number of pre-orders (block 53)—i.e. the aggregate amount that potential buyers have expressed an interest in buying since the start of the offer; and optionally, the number of buyers in the Buying Group so far (block 53); the date and time limit for the offer (block 54) as entered by the seller (46); an optional status message (block 55) (e.g. “confirmed!” or “sold out!”); and a “add Pre-order(s)” button (block 56) that potential buyers can click if they are interested adding pre-order(s) to this offer. In an alterative embodiment, potential buyers can click on another part of the screen displaying the offer to indicate their interest in adding a pre-order(s) to an offer. In such an embodiment, the “add pre-order” button would be optional. (The “add pre-order” button can also go by other names, such as “Buy Now”, “Buy” or any other word or phrase intended to invite potential buyers to add a bid.)

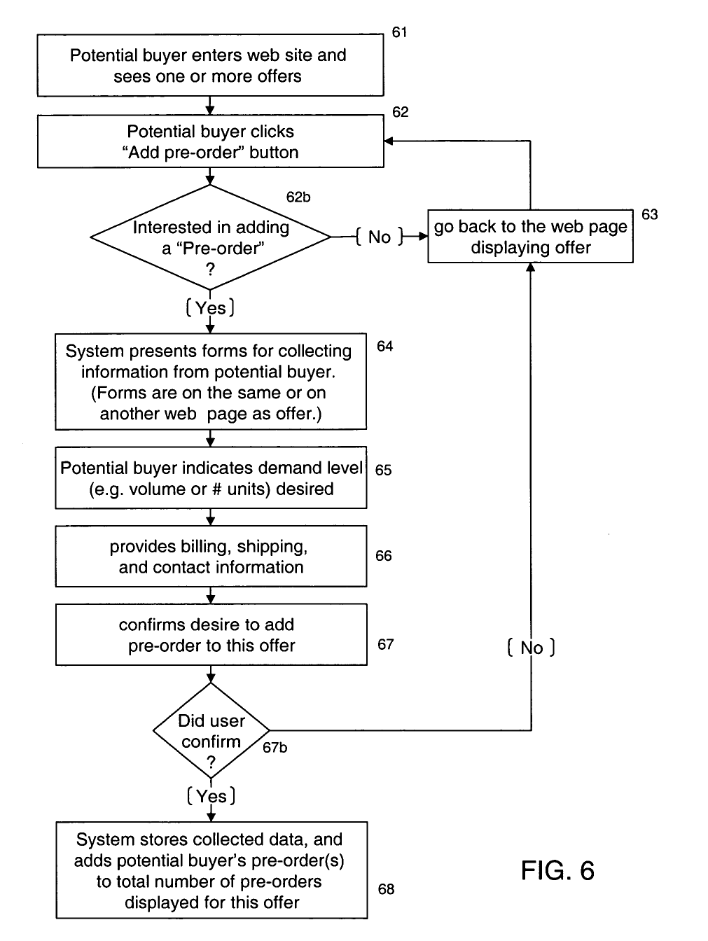

FIG. 6 is a program flow diagram of the operations that occur when a potential buyer adds a Pre-order. (Block 34). If a potential buyer sees an offer displayed on a web site (block 61), and wants to add his or her pre-order(s) to the offer, the potential buyer can indicate a desire to do so (62 and 62b) by clicking on the “add pre-order” button. In that case, the system proceeds to walk the potential buyer through the process of signing up to add pre-order(s) to this offer.

The system will present forms (block 64) to collect information from the potential buyer, presenting the forms either on the same web page where the offer was presented or on separate web pages linked to that first web page. The buyer enters the amount (e.g. the volume or number of units) they are interested in buying if this offer goes through (block 65). This is the potential buyer's individual “demand” level. For example, if the offer is for CDs, the user might indicate an interest in buying 5 CDs. The potential buyer also provides his or her billing information (for example, credit card number and expiration date and billing address), shipping address, and contact information (block 66). Preferably an e-mail address is provided as part of the contact information. The potential buyer then gets a chance to confirm whether he or she really wants to add pre-order(s) after all (block 67). It will be noted that a more rapid system of adding and subtracting pre-orders will facilitate a “real time” and “wall Street-like” buying experience. In such a case, variables above could be limited. For example, the billing information could be given before the potential buyer decides to add a pre-order, and the amount of pre-orders a potential buyer may add or subtract could be limited to a set quantity. (e.g. one pre-order moved each time add or remove button is clicked). An unlimited Maximum Available Amount is preferred in this case. The speed or particular steps in adding or removing changeable bids, however, is not relevant to the invention.

When the potential buyer confirms his or her interest in joining the Buying Group (block 67b), then the system stores the collected data in a central database (part of the software on the servers 13) and the system recalculates the Aggregate Demand for this offer (block 68). The Aggregate Demand is the sum of each buyer's individual demand level. For example, if there are three buyers so far for the domestic appliance example mentioned earlier, with the first expressing an interest in buying 5 units, the second indicating an interest in buying 1 unit, and third indicating an interest in buying 20 units, then the Aggregate Demand so far is 5+1+20=26 balls. If the seller is selling wheat instead of domestic appliances, then the Aggregate Demand might be expressed in lbs. of wheat instead of # of units. Likewise the demand could be in terms of hours of a particular service that is being offered.

The system will not allow a buyer to request more units than are available—i.e. more units than the Maximum Available Amount specified by the seller, factoring in the Aggregate Demand already expressed by other Buying Group members plus the number of units requested by the new potential buyer. If the new potential buyer requests too many units, the system will display a message on the web site telling the new potential buyer how many units are left, and then allow the new potential buyer to re-enter a lower desired number of units (block 65). Naturally in some situations a seller might have a virtually unlimited number of units available if at least a certain number of products are ordered.

The changeable and non-binding nature of the pre-order requires that the potential buyer be given the faculty of changing or canceling his or her bid before the highest aggregate demand threshold is reached or before the time/date limit is reached. For this reason a “remove pre-order” button is made available or in another embodiment an “add/remove pre-order” button could replace the two buttons (that is, the add pre-order button and the remove pre-order button).

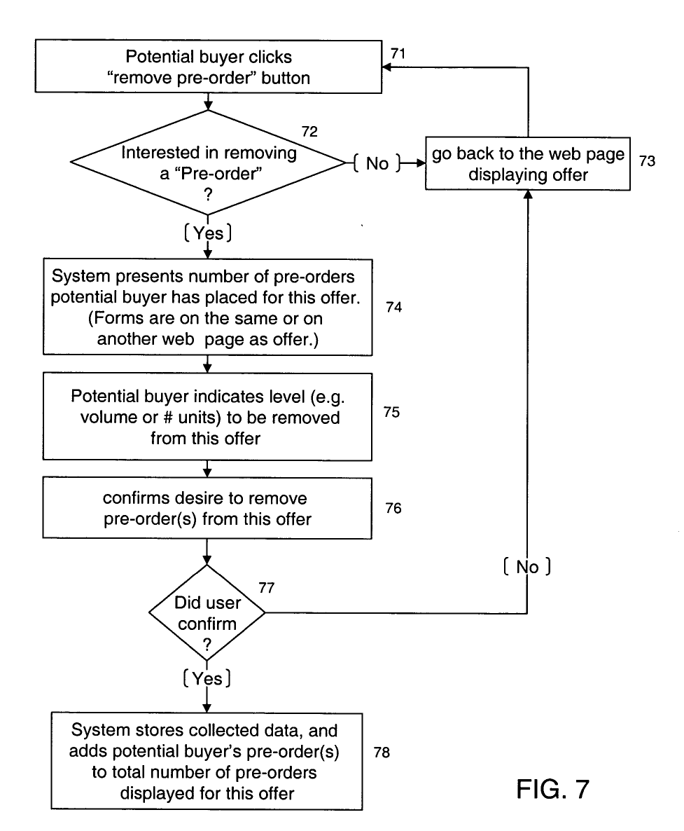

FIG. 7 is a program flow diagram of the operations that occur when a potential buyer removes a Pre-order or pre-orders. (Block 34). If a potential buyer wants to remove his or her pre-order(s) from an offer, the potential buyer can indicate a desire to do so (71 and 72) by clicking on the “remove pre-order” button. In that case, the system proceeds to present the number of pre-orders the potential buyer has placed for this offer (block 74). The system will present this information to the potential buyer either on the same web page where the offer was presented or on separate web pages linked to that first web page.

The buyer enters the amount of pre-orders they are interested in removing from this offer (block 75). The potential buyer then gets a chance to confirm whether he or she really wants to add pre-order(s) after all (block 76). As noted above, a more rapid system of adding and subtracting pre-orders will facilitate a “real time” and “wall Street-like” buying experience. In such a case, an embodiment with an “add pre-order(s)” button and a separate “remove pre-order(s) button” is preferred. In addition, as mentioned above limiting the number of pre-orders a potential buyer may add or subtract to a set quantity will further augment the efficacy of the trend generating aspect of the present system and method. The speed or particular steps in adding or removing changeable bids, however, is not relevant to the invention.

When the potential buyer confirms his or her interest in removing one or more pre-orders (block 77), the system stores the collected data in a central database (part of the software on the servers 13) and the system recalculates the Aggregate Demand for this offer (block 78).

As described earlier, and as indicated by blocks 33b, 36, and 38, the system monitors aggregate demand, and time and date limits, during each offer's buying cycle. If the Aggregate Demand rises to the Maximum Available Amount (block 36) for an offer, or if the time or date limit has passed (block 33b) but Aggregate Demand has risen to at least the lowest Demand Threshold (38) by that time, then the system will display a “sold out” status message and stop accepting bids for this offer (block 35). However, if the time and date threshold pass (block 33b), and the Aggregate Demand is still below the lowest Demand Threshold (block 38) at that time, then the system proceeds to the “Offer Cancelled” stage (block 39).

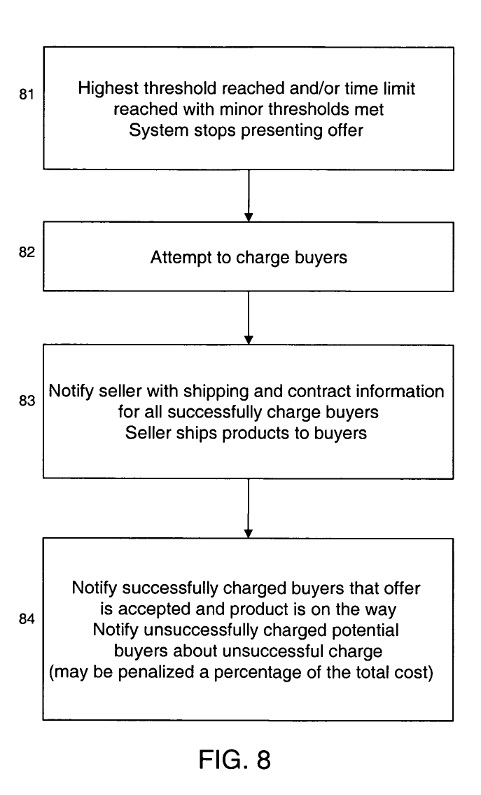

In FIG. 8, the system first stops presenting the offer if the Highest Demand Threshold is reached and/or the time limit reached with minor thresholds being met. (block 81). The system displays a message indicating that the offer had been completed successfully. For example the message could be “confirmed!”. The system then uses the Aggregate Demand (calculated at block 68 and 78), and the set of Demand Thresholds and associated prices provided by the seller when setting up the offer (block 32), to determine the final price each buyer will have to pay for the product being offered (block 82). For example, if a seller offered 250-499 soccer balls for $15 each or 500-700 soccer balls for $10 each, and the buyers expressed, collectively, a desire to buy 272 soccer balls (i.e. their Aggregate Demand is 272), then the price they would have to pay would be $15 per ball. But if the Aggregate Demand by the end of the offer period met or exceeded 500 units, they would only have to pay $10 per ball.

After determining the final price (block 82), each potential buyer is charged (block 83) using the credit card information previously supplied by each buyer (block 66). Each buyer is charged the price times the number of units they are buying (as they indicated previously in block 65), plus any applicable tax and shipping & handling charge (if any). The system keeps track of which buyers were successfully charged. In some cases, credit card charges may not go through—for example, if a potential buyer's credit card has expired or is over its credit limit. In alternative embodiments, the system can automatically create invoices for buyers who prefer to be billed rather than paying by credit card.

The system notifies the seller that the offer has gone through, and provides the shipping and contact information for each successfully charged Buyer (block 84). The seller then ships the number of units requested by each successfully charged buyer (block 65) to that buyer. In alternative embodiments, the Seller could ship all of the units, in bulk, to a fulfillment company or to the System operator, who would handle shipping subsets of the units to individual Buyers. In the case where the thing being purchased is a service, rather than a product, the seller would perform the purchased service for the buyer, rather than shipping any product.

Finally, successfully charged buyers are notified that the offer has been accepted, that they have been charged, and that the products are on their way (block 85). Potential buyers who were not successfully charged are notified (block 85) about the unsuccessful charge and no product is shipped to them.

As described above, if an offer's Time & Date limit passes (block 33b) and Aggregate Demand is still below the lowest Demand Threshold (block 38), then the system proceeds to the “Offer Cancelled” processing stage (block 39). When this occurs, the system stops presenting the offer (block 91). The system can display a message indicating that the offer has been cancelled. The seller is notified that the offer has been cancelled because of insufficient demand (block 92). Finally, potential buyers who had expressed interest in joining the Buying Group for this offer are notified that the offer has been cancelled because of insufficient demand (block 93).

The embodiment illustrated in FIG. 1 displays the offers on a web site run by the System Operator on a web server that is part of the system controller 13. For example, if XYZ Corp. wanted to offer group discounts on their own web site, using their own software to manage the process, they would implement a system like the one illustrated in FIG. 1. The embodiment shown in FIG. 1 could also be used to display offers on more than one web site hosted on the same servers used for the system controller 13.

Various other alternative embodiments of the invention are possible:

An alternative embodiment of the system displays offers on one or more web sites run by other web-site operators who may differ from the System Operator, on web servers that are not part of the system controller 13.

Another alternative embodiment could present establish different criteria for determining when the pre-orders become binding. For example, it may be determined that the pre-orders will only become binding upon reaching a time limit. In this case the potential buyers could change their minds even after the highest aggregate threshold is reached. A second example could be one in which no time limit is established. In this case the pre-orders would become binding upon reaching a pre-determined threshold.

Another alterative embodiment could be one in which a single seller offers a volume discount on one or more products to one or more buyers through the seller's own web site. For example, an online retailer company could use this simpler embodiment of this invention to offer a volume discount on his or her own web sites using the system of the present invention to present the offer. A system in accordance with the present invention would automatically accept indications of interest (i.e. aggregate demand) from one or more people who are interested in purchasing the retailer's product(s).

Yet another embodiment of the invention could also allow sellers or the system operator 13b to place more constraints on the offers. For example, they might place a limit on how many units any single buyer can request.

The method and system of the present invention have applications on the Internet as well as in conventional communications systems such as voice telephony (including hand-held mobile devices) and other communications systems such as two-way television (a.k.a. interactive television) and WebTVs. Any device that can present information (visually, audibly, or otherwise) can be used to present offers. Any device that can accept input from people (directly or indirectly through other devices) can be used to accept indications of interest.

The products offered for sale using the various embodiments of the invention can be products that are offered for sale by the System Operator. Alternatively, the System Operator can merely provide a facility that is used by others to offer products for sale. In such a case the System Operator will only receive a commission for operating the system and the remainder of the purchase price will go to the actual Seller. The method of compensation, however is not relevant to the present invention.

In the embodiments thus far described, the buyers are charged by means of a credit card. Other alternative methods of payment can also be used. For example, the seller could invoice the buyer, or potential buyers could be required to maintain a deposit account with the system operator. Various other payment mechanisms could be employed. The method of payment or means of payment collection, however, are not relevant to the present invention.

A skilled programmer could follow the specifications described herein and build a system that utilizes the present invention. It should be understood that while various preferred embodiments of the invention have been described, those skilled in the art could make various changes in form and detail without departing from the spirit and scope of the invention. Applicant's invention is limited only by the scope of the appended claims.

### FIELD OF THE INVENTION

The invention relates to electronic commerce as well as physical auction venues and more particularly to a method and system for generating sales trends and volume.

US PATENT DOCUMENTS

| | | |
|---|---|---|
| 3581072 | May, 1971 | Nymeyer. |
| 4567359 | January, 1986 | Lockwood. |
| 4789928 | December, 1988 | Fujisaki |
| 4949248 | August, 1990 | Caro. |
| 5148365 | September, 1992 | Dembo |
| 5255184 | October, 1993 | Hornick et al. |
| 5270921 | December, 1993 | Hornick |
| 5377095 | December, 1994 | Maeda et al. |
| 5576951 | November, 1996 | Lockwood. |
| 5615109 | March, 1997 | Eder |
| 5640569 | June, 1997 | Miller et al. |
| 5712985 | January., 1998 | Lee et al. |
| 5724521 | March, 1998 | Dedrick. |
| 5727165 | March, 1998 | Ordish et al. |
| 5729700 | March, 1998 | Melnikoff |
| 5745882 | April, 1998 | Bixler et al. |
| 5758327 | May, 1998 | Gardner et al. |
| 5758328 | May, 1998 | Giovannoli. |
| 5765143 | June, 1998 | Sheldon et al. |
| 5794207 | August, 1998 | Walker et al. |
| 5794219 | August, 1998 | Brown. |
| 5797127 | August, 1998 | Walker et al. |
| 5799284 | August, 1998 | Bourquin. |
| 5806047 | September, 1998 | Hackel et al. |
| 5809144 | September, 1998 | Sirbu et al. |
| 5818914 | October, 1998 | Fujisaki. |
| 5826244 | October, 1998 | Hubermann. |
| 5832459 | November, 1998 | Cameron et al. |
| 5835896 | November, 1998 | Fisher et al. |
| 5842178 | November, 1998 | Giovannoli. |
| 5845265 | December, 1998 | Woolston |
| 5845266 | December, 1998 | Lupien et al. |
| 5890137 | March, 1999 | Koreeda. |
| 5890138 | March, 1999 | Godin et al. |
| 5895454 | April, 1999 | Harrington. |
| 5897639 | April, 1999 | Greef et al. |
| 5913210 | June, 1999 | Call. |
| 5915209 | June, 1999 | Lawrence. |
| 5950176 | September, 1999 | Keiser et al. |
| 5956709 | September, 1999 | Xue. |
| 5983199 | November, 1999 | Kaneko. |
| 6021398 | February, 2000 | Ausubel |
| 6026383 | February, 2000 | Ausubel |
| 6035288 | March, 2000 | Solomon. |
| 6041308 | March, 2000 | Walker et al. |
| 6055504 | April, 2000 | Chou et al. |
| 6067528 | May, 2000 | Breed et al. |
| 6076070 | June, 2000 | Stack. |
| 6078897 | June, 2000 | Rubin et al. |
| 6081789 | June, 2000 | Purcell. |
| 6085169 | Jully, 2000 | Walker et al. |
| 6101484 | August, 2000 | Halbert et al. |
| 6119101 | September, 2000 | Peckover. |
| 6141653 | October, 2000 | Conklin et al. |
| 6161099 | December 2000 | Harrington et al. |
| 6260024 | Jully, 2001 | Shkedy |
| 6269343 | Jully, 2001 | Pallakoff. |
| 6332129 | December, 2001 | Walker et al. |
| 6584451 | June, 2003 | Shoham et al. |
| 6604089 | August, 2003 | Van Horn et al. |
| 6631356 | October, 2003 | Van Horn et al. |
| 6671674 | December, 2003 | Anderson et al. |

FOREIGN PATENT DOCUMENTS

| | | |
|---|---|---|
| 0845747 | June, 1998 | EP. |
| 1077422 | February, 2001 | EP. |
| WO 01/79961 | October, 2001 | WO. |
| WO 00/11570 | March, 2000 | WO. |
| WO 00/30004 | May, 2000 | WO. |
| WO 00/30005 | May, 2000 | WO. |
| WO 00/34841 | June, 2000 | WO. |
| WO 00/34842 | June, 2000 | WO. |
| WO 00/34843 | June, 2000 | WO. |
| WO 00/34886 | June, 2000 | WO. |
| WO 45318 | August, 2000 | WO. |

### OTHER REFERENCES

Sevino, Nick; “Auction Bidding Is Non-Binding?” AuctionBytes.com,
Number 105—Oct. 19, 2003—ISSN 1528-6703, Oct. 19, 2003.
Kuchinskas, Susan; “Shopping Engine Bidding Gets Smarter” Click Z News,
http://www.clickz.com/news/article.php/3287241, Dec. 9, 2003.
“Shopping.com(™) Launches New Smart Bidding System” PR Newswire,
http://www.cheaphostingdirectory.com/news/20031209shopping.htm, Dec. 9, 2003.
Diorio, Carl; “Artisan bids roll in” vbusiness.com,
http://www.variety.com/index.asp?layout=upsell_article&articleID=VR1117886530&categoryID=18&cs=1, May 19, 2003.
Online Document from Biddeals.co.uk, “Non-Binding Bid Policy”
http://www.biddeals.co.uk/api .cgi?ctry=UK&ref=&action=&services=&user=&community=png-nbb&help=&basics=&why=&username=&affiliate=, Posted Jul. 11, 2004.
Gottlieb, Bruce; “Does Group-Shopping Work? ,” Slate MSN,
http://slate.msn.com/?id=86925, Jul. 26, 2000.
Geralds, John; “Group buying market poised to soar” vnunet.com,
http://www.vnunet.com/analysis/602559, Apr. 26, 2000.
Needle, David; “Group buying market poised to soar” internews.com,
http://siliconvalley.internet.com/news/article.php/3531_{—}551521, Jan. 4, 2001.
Letter from Woolcott dated Aug. 31, 1999 and Search Report.
http://www.storesearch.com/.
http://shop.netscape.com/auctions/main .adp.
Http://auctions.yahoo.com/.
Http://www.lycos.com/Shopping/sales_and_specials/.
Online Document from Software Patent Institute Database of Software Technology,
http://m.spi.org/, Record 1: “Management Data Processing,” Serial No. acmr6512.0039, Printed Sep. 20, 1999.
Management and Specialist Team, LetsBuylt.com, http://www.euroferret.com, Jan. 15, 1999; Online Document, http://www.alumni.se/e-commerce/default.htm, Jan. 15, 1999, Printed Nov. 19, 1999.
Online Document from Bid.com, http://www.bid.com/dutch, Printed Sep. 3, 1999.
Online Document from Bullnet Online Auctions,
http://www.bullet.co.uk/auctions/info.htm, Printed Sep. 3, 1999.
Online Document from American Way, “How Airline Pricing Works,”
http://www.aa.com/away/Vantage/vantage-may98.htm, Printed Mar. 18, 1999.
Online Document from Airline Discount, http://faculty.darden.edu/pfeiferp/airline.htm, Printed Mar. 18, 1999.
U.S. provisional application No. 60/097,932, Pallakoff, filed Aug. 25, 1998.
U.S. provisional application No. 60/097,933, Pallakoff, filed Aug. 25, 1998.
“Frontier Rings Up A Sale With National Retail Federation,” PR Newswire, p119NYM057, Jan. 19, 1998.
“ONSALE Home;” ONSALE; Sep. 8, 1997.
Marrinucci, Sandra; “Net proves a boon to research;” Electronic Engineering Times, Sep. 22, 1997.
Bailey et al; “A Exploratory Study of the Emerging Role of Electronic Intermediaries;”
International Journal of Electronic Commerce, vol. 1, n 3, p. 7-20, Spring 1997.
Negromante, Nicholas; “Psst! Transactions;” Forbes, 80th Issue, Jul. 7, 1997.
“National Federation Selects GE Information Services for EDI Service Partnership,” PR Newswire, p1006DCM009, Oct. 6, 1997.
Ferranti, Marc; “Electronic Commerce: Ties That Bind;” InfoWorld, vol. 19, N 14, p. 59-62, Apr. 7, 1997.
“NRF: home page on World Wide Web (National Foundation Launches Site),” The Weekly Newspaper for the Home Furnishing Network, v70, N 42, p. 10(1), Oct. 14, 1996.
Sairamesh et al.; “Economic Framework for pricing and Charging in Digital Libraries;”D-Lab Magazine, ISSN 1082-9873, Feb. 1996.
“Retail Ferderation Group Buying Set,” HDF-The weekly Home Furnishings Newspaper, v0, n0, p. 9, Dec. 26, 1994.
“NRF: home page on World Wide Web (National Foundation Launches Site),” The Weekly Newspaper for the Home Furnishing Network, v70, N 42, p. 10(1), Oct. 14, 1996.
“Retail Federation Group Buying Set,” HDF-The Weekly Home Furnishings Newspaper, v68, N 52, p. 9(1), Dec. 26, 1994.
“Mosher views ARA as survival kit for small specialty stores,” Daily News Record, v24, N 22, p. 4(1), Feb. 2, 1994.
Lai, Rajiv; Staelin, Richard; “An Approach for Developing an Optimal Discount Pricing Policy;” Management Science, vol. 30, N 12, #1524, Dec. 1984.

1. A method for generating buying trends among buyers in an auction venue comprising the steps of:
Presenting one or more products with associated prices determined by aggregate demand thresholds; Placing non-binding and changeable bids. Establishing one highest aggregate demand threshold and optionally, one or more minor aggregate demand thresholds. Optionally, establishing a time or date limit determining the end of the auction on particular product; Establishing a controller to monitor and record the desire of buyers to place or to subtract a changeable bid from said product or products.

2. The method recited in claim 1 wherein said non-binding and changeable bids are bids that become binding in such a time as said highest aggregate demand threshold shall be met and/or in such a time as said time or date limit (if any) shall be reached and a minor aggregate threshold (if any) shall be met.

3. The method recited in claim 2 wherein said non-binding and changeable bid shall further be rescindable at any time before said time or date limit.

4. The method recited in claim 1 wherein said controller may comprise one or more human beings or an electronic or mechanical device.

5. A system for generating buying trends among buyers in a physical or electronic auction venue comprising:
A system for aggregating demand for the purchase of one or more products comprising: a controller; seller terminals which communicate with said controller whereby sellers can enter and transmit, prior to the beginning of a specified and limited time period, to said controller, a conditional sales offer for said product(s), said conditional sales offer specifying prices which are dependent upon the total number of said product(s) associated with said conditional sales offer purchased in the specified and limited time period; web pages which display said conditional sales offer; buyer terminals which communicate with said controller whereby said buyers can indicate to said controller a desire to place a non-binding and changeable bids on product(s) offered, and; said controller calculating the price from among the specified prices for said product(s) dependent upon said conditional sales offer and an aggregate amount of said product(s) that said buyers have collectively indicated a willingness to purchase during said specified and limited time period by using changeable and non-binding bids.

6. The system recited in claim 5 operating in accordance with said specified and limited time period whereby bids for a particular product are only accepted for said specified and limited time period.

7. The system recited in claim 5 wherein said system makes available said conditional sales offer to one or more web sites.

8. The system recited in claim 5 wherein said seller terminals are terminals connected to the Internet.

9. The system recited in claim 5 wherein said conditional sales offer includes different prices for different quantities of products.

10. The system recited in claim 5 wherein said controller comprises a server.

11. The system recited in claim 5 wherein said seller terminals and said potential buyer terminals communicate with said controller via the Internet.

12. A system for generating buying trends among buyers in a physical or electronic auction venue comprising:
One or more products with associated prices determined by aggregate demand thresholds;
Non-binding and changeable bids which become binding when the highest aggregate demand threshold is met or when the date or time limit is reached and a minor aggregate threshold is met;
A time or date limit determining the end of auction on particular product;
A mediator monitoring the desire of buyers to place or to subtract a changeable bid from said product.

13. A method of predicting demand for a product or products.

14. The method recited in claim 13 wherein the method described in claim 1 shall be used for products which have not yet been produced.
